(19) United States
(12) Patent Application Publication
(10) Pub. No.: US 2022/0355323 A1
(43) Pub. Date: Nov. 10, 2022

(54) METHOD FOR MONITORING THE MEDIA FLOW OF A JET OF DROPLETS

(71) Applicant: AOM-Systems GmbH, Heppenheim (DE)

(72) Inventors: Simon ROSENKRANZ, Bensheim (DE); Walter SCHÃFER, Weinheim (DE)

(73) Assignee: AOM-Systems GmbH, Heppenheim (DE)

(21) Appl. No.: 17/313,561

(22) Filed: May 6, 2021

(51) Int. Cl. B05B 12/08; B05D 1/02

(52) U.S. Cl. CPC B05B 12/082; B05D 1/02; G01N 15/0211

(57) ABSTRACT

A method for monitoring the media flow of a jet of droplets is intended to enable reliable process management, especially in industrial applications, in a particularly simple and resource-saving manner. For this purpose signal signatures assigned to individual droplets are continuously recorded by time-resolved measurement of the intensity of the scattered light of a light beam crossing the droplet beam, from which a diagnostic parameter characteristic of the droplet beam is determined.

### FIELD OF INVENTION

The invention relates to a method for monitoring the media flow of a jet of droplets and to a method for producing a coating. The invention also relates to a method for operating a painting or coating device or a spray drying system or spray adhesive system.

### BACKGROUND OF INVENTION

In a large number of industrial applications, atomization or spraying processes are used in which a medium, in particular in the form of a liquid, is atomized and then made available in droplets or in particles, i.e. as a spray, for a subsequent processing step. In particular, such spraying or atomization processes are used in painting or other coating processes, in particular spray painting, of components or complete assemblies, for example in the automotive industry, in coating processes for the production of functional layers, for example in the pharmaceutical industry, in injection processes, for example of fuels, for spray bonding processes, used in spray drying or in similar processes. The actual atomization can take place, for example, using one or two-substance nozzles, using high-speed rotary or ultrasonic atomizers or also using so-called swirling nozzles.

In industrial applications in particular, precise monitoring of the media flow of the spray or droplet jet produced by atomization is usually necessary or at least desirable, especially with regard to possibly specified target values for coatings such as layer thicknesses or the like. Changes or variances in the atomization process or in the spray generated with it should, if possible, be detected in real time while the (production) process is running. Variances in the spray refer, among other things, to the change in the quality of the spray or spray result in relation to the coating properties, which is generally composed of the droplet size, droplet speed and the number of droplets.

Changes of this kind can occur in an ongoing production process for various reasons, for example contamination, wear and tear or defects in an atomizer or a nozzle, changes in the spray or coating medium, for example when the drip time is exceeded, changes in operating parameters such as pressure changes, changes in position, changes in the route or the driving speed of a robot, contamination, wear and tear or defects in the supply to the nozzle, for example due to deposits or contamination in the ring line or the supply air, changes in the environmental parameters, for example due to changes in temperature or humidity, changes in the atomization parameters, for example when the electrical fields change in electrostatic painting, or operating errors in humans.

There is therefore generally and especially in industrial coating processes such as functional coatings or decorative coating, the desire, especially with regard to an “inline” quality control for the coating process, preferably in real time, to enable for continuous monitoring of the media flow of the droplet jet and the parameters characteristic of the droplets such as droplet size, speed, etc. For this purpose, systems can be used with which the determination of various characteristic properties of individual particles or droplets, in particular with a size in the range of

millimeters and smaller, is possible. The simultaneous determination of both the size and the speed of individual particles can be of particular interest, since this information can be used to determine a flux density such as a mass flow or a volume flow. In addition, individual particles can be identified and individually characterized in a large number of particles, such as individual droplets in an aerosol or spray.

Various measurement methods are known for this from practice. In many cases, optical measurement methods are advantageous because they do not influence, or do not influence significantly, the individual particles, the properties of which are to be determined. From DE 10 2014 211 514 A1, a method and a system are known in this context with which the measurement of individual particle properties and thus also of throughput as well as volume and mass flow in the droplet jet are made possible, using the so-called time shift method and the time shift measuring devices used for this.

### BRIEF SUMMARY OF INVENTION

It is now an object of the invention to provide a method for monitoring the media flow of a jet of droplets, which is even further simplified compared to the prior art, with which a reliable process control is made possible in an especially resource-saving manner, especially in industrial applications.

This object is achieved according to the invention in that signal signatures assigned to individual droplets are continuously recorded by time-resolved measurement of the intensity of the scattered light of a light beam crossing the droplet beam, from which a diagnostic parameter characteristic of the droplet beam is determined.

“Diagnostic parameter” is to be understood here in particular as a parameter or a characteristic value that is provided as an input variable for a downstream diagnostic, control, or regulating device or for machine learning processes and there for any diagnostic purposes in monitoring the droplet jet or can also be used for control or regulation interventions in the actual process management. In particular, such a diagnostic parameter can be a more qualitative parameter such as, for example, “process parameters in order”, “tracking necessary” or the like, or also a quantitatively further processable parameter such as a key figure.

The invention is based on the idea that reliable process monitoring and control is already possible with the systems already known, in particular with the system based on the time shift method known from DE 10 2014 211 514 A1. In such systems, however, characteristic parameters such as droplet size or the like are usually first explicitly determined for single, individual droplets and then made available for further processing. This requires a comparatively high expenditure in terms of equipment and computation. In contrast, a significant simplification without impairing the reliability relevant for process control can be achieved by largely ignoring the determination of parameters characteristic of the individual droplets and instead using the signal signature or the signal structure determined for the respective droplets directly for determining the characteristic diagnostic parameter for the droplet jet instead of for an individual droplet.

In the provided time-resolved measurement of the scattered light of the light beam crossing the droplet beam, use is made of the knowledge that a particle traversing the light beam usually emits different scattered components or reflects them. These light components can be received by the assigned radiation detector(s) and displayed via a time-resolved intensity distribution. The different scatter components include reflections, surface waves and refractions of various orders and their modes, which reach the respective radiation detector with a time delay. Therefore, a droplet traversing the light beam generates a characteristic signature in the case of time-resolved measurement, which can be quantitatively recorded and evaluated using a number of assigned parameters. The respective signal signature based on one or more of the evaluation parameter(s) or evaluation parameter vectors maximum amplitude, total energy (corresponding to the time integral over the amplitude curve), frequency of occurrence of the signal signatures per unit of time, Fourier transform of the signal structure, and/or wavelet transform of the signal structure is considered particularly suitable and therefore particularly preferred for determining the diagnostic parameter.

In this way, quantitative evaluation parameters can be determined, it being possible for the diagnostic parameter to be determined, for example, by comparing the currently determined evaluation parameter with an assigned tolerance band. In such a case, for the case that the maximum amplitude of the signal signature is within a specified tolerance band, a “system ok” information could be generated as a diagnostic parameter and output to the process control so that no further control intervention takes place. Otherwise, i.e. if the maximum amplitude lies outside the intended tolerance band, information could be output as a diagnostic parameter that triggers a readjustment on the nebulizer.

Alternatively, the determined evaluation parameter, for example the maximum amplitude of the signal signature, could be quantitatively output directly to the process control as a diagnostic parameter and used there as a reference variable, with the atomization process being corrected until the maximum amplitude is again in the assigned tolerance band.

In a particularly advantageous embodiment, however, the diagnostic parameter is determined on the basis of deviations from signal signatures detected with a time offset from one another. This particularly preferred embodiment is based on the consideration that a particularly stable process control is sought as a design goal, in which the essential parameters should not change as far as possible in stable operation. In this preferred embodiment, which can be implemented in a particularly simple and resource-saving manner, an alarm or notification signal is output as a diagnostic parameter if the signal signatures change in an undesirable manner over time.

In accordance with a particularly advantageous embodiment, a particularly high operational and procedural security in the process management can be achieved by validating the signal signatures on the basis of the comparison with a stored target profile, with only the signal signatures recognized as valid being taken into account when determining the diagnostic parameters. In particular, it is checked whether the recorded signal signatures match at least qualitatively with an assigned profile. If this is the case, it can be concluded that it is a “real” detected droplet that must be taken into account in the evaluation; otherwise, a noise event is identified and the measured signal is discarded.

The method can be carried out using only one detector. However, a plurality of detectors is advantageously used to detect the signal signatures. In the evaluation in the manner of an additional parameter, this enables the time offset of the signal signatures between different detectors to be evaluated in a particularly advantageous development for determining the diagnostic parameter.

In an embodiment that is regarded as independently inventive, the method is used to operate a paint shop, the throughput of the sprayed paint droplets being monitored using a method of the type described above and the diagnostic parameter determined being used as an input variable for controlling the paint shop.

In an alternative embodiment, which is also regarded as independently inventive, the method is used to operate a spray drying system, the throughput of the food particles being monitored using a method of the type described above and the diagnostic parameter determined being used as an input variable for controlling the spray drying system.

The advantages achieved with the invention are, in particular, that the evaluation of the signal signature per se, in particular without an intermediate determination of the individual droplet properties, enables reliable process monitoring in a particularly simple and resource-saving manner. By measuring the spray variance, i.e. determining deviations in the signature parameters relative to one another, the consumption of time, material, CO₂ and the like, as well as production scrap or the number of parts that have to be reworked, can be kept particularly low. Downstream (or alternative) quality assurance procedures can also be wholly or partially saved.

### BRIEF DESCRIPTION OF THE DRAWINGS

An embodiment of an invention is explained in more detail with reference to a series of drawings.

FIG. 1 depicts a monitoring system for a jet of droplets,

FIG. 2 depicts a signal signature,

FIGS. 3a and 3b depict an intensity spectrum of a noise event (FIG. 3a) in comparison with the intensity spectrum of a signal signature of a droplet (FIG. 3b), and

FIGS. 4a and 4b depict an example of a diagram for the development of a monitored parameter over time, on the one hand in a stable normal case (FIG. 4a) and on the other hand when a fault occurs (FIG. 4b).

The same parts are provided with the same reference numerals in all figures.

### DETAILED DESCRIPTION

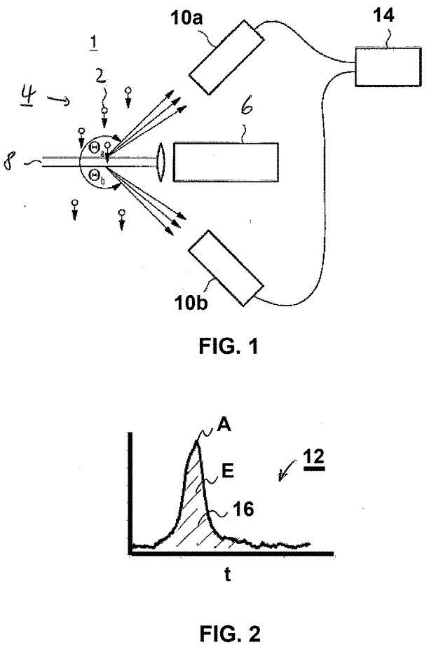

The monitoring system 1 according to FIG. 1 is intended and designed for monitoring a droplet jet 4 formed by a large number of particles or droplets 2, for example the sprayed paint droplets of a painting system or the food particles of a spray drying system or the adhesive particles of a spray bonding system or the droplets of an injection system. For this purpose, the monitoring system comprises a light source 6 which emits a focused light beam 8. Furthermore, two radiation detectors 10a, 10b are provided in the exemplary embodiment, which are arranged at an angle Θ_{a,b} of approximately Θ_{a,b}=150°-170° to the light beam 8. The radiation detectors 10a, 10b measure scattered components of the light beam 8 which are reflected or emitted by a particle passing through the light beam 8, for example a droplet 2 or a particle. These scatter components can be, among other things, reflections, surface waves and refractions of various orders and their modes. The various scatter components arrive at the first radiation detector 10a with a first time delay and also with a second time delay at the second radiation detector 10b. In the exemplary embodiment shown, two radiation detectors 10a, 10b are thus provided so that the monitoring system 1 shown could be part of a conventional time-shift measuring system with regard to its components and its structure. Alternatively, however, only one detector or a larger number of detectors could also be provided.

In the measurement volume predetermined by the light beam 8, droplets 2 flying past scatter the light so that it can be detected with the radiation detectors 10a, 10b. The scattered light of the individual droplets 2 is converted into a signal in the respective detector 10a, 10b. The time-resolved signal recorded and measured over time results in a time-resolved intensity profile recorded in each case at each detector 10a, 10b, referred to below as signal signature 12, as shown by way of example in FIG. 2. Such a signal signature 12 is usually, i.e. under usual volume and mass flows, each assigned to a single droplet 2. In the monitoring system 1, signal signatures 12 assigned to individual droplets 2 are continuously recorded by time-resolved measurement of the intensity of the scattered light of the light beam 8 crossing the droplet beam 4. The basic profile of such a signal signature 12 results from the measurement process, the fact that the droplets 2 pass through the light beam 8 at a certain speed, and from the various scatter contributions already mentioned above. The time-resolved intensity curves or signal signatures 12 detected by the radiation detectors 10a, 10b can then be evaluated by an assigned evaluation unit 14 of the monitoring system.

The signal signature 12 shown as an example in FIG. 2 can be quantitatively described on the basis of some suitably selected parameters that are also suitable for use as evaluation parameters in the evaluation unit 14 and can thus be characterized in a suitable manner for an evaluation. The maximum amplitude A of the signal curve within the signal signature 12 and/or the total energy E of the signal represented by the respective signal signature 12 are particularly suitable and provided as characteristic parameters. The total energy E corresponds to the time integral over the amplitude curve of the signal signature 12 and thus to hatched area 16 shown in FIG. 2, included by the amplitude curve. Further parameters that can be used for the evaluation in the evaluation unit are the frequency of occurrence of the signal signatures 12 per unit of time and, in the case of the use of two or more radiation detectors 10a, 10b also shown in the exemplary embodiment, the time offset between two signal signatures 12 from different detectors 10a, 10b.

The monitoring system 1 and in particular its evaluation unit 14 are designed for a particularly reliable and simplified monitoring of the media flow of the droplet jet 4, with which a reliable process control of the downstream process, for example in a paint shop or in a spray drying system, is made possible in a particularly resource-saving manner. For this purpose, the evaluation unit 14 is designed to specifically use the detection of the signal signatures 12 assigned to the respective individual droplets 2 for a cross or relative comparison of the signal signatures 12 with one another in order to determine a diagnostic parameter that can be used in the actual system process. It can thus be monitored in particular whether the determined signal signatures 12 remain essentially constant over time within a specified tolerance range (from this it can be concluded, for example, that the system process is running in a stable manner and thus there is no need for action or intervention), or whether a temporal change in the signal signatures 12 takes place (from this, for example, it can be concluded that there is a malfunction or a defect in the process that requires action or intervention). In particular, the deviations from signal signatures 12 detected with a time offset from one another are thus evaluated. This design, i.e. in particular the use of the recorded signal signatures 12 in a cross or relative comparison, allows for using the monitoring system 1 from the signal signatures 12 directly to determine a diagnostic parameter characteristic of the droplet jet 4 and making it available for subsequent further processing. The explicit calculation of diagnostic parameters characteristic of individual droplets per se, which in conventional systems might be necessary in the manner of an intermediate step, is not necessary in this embodiment.

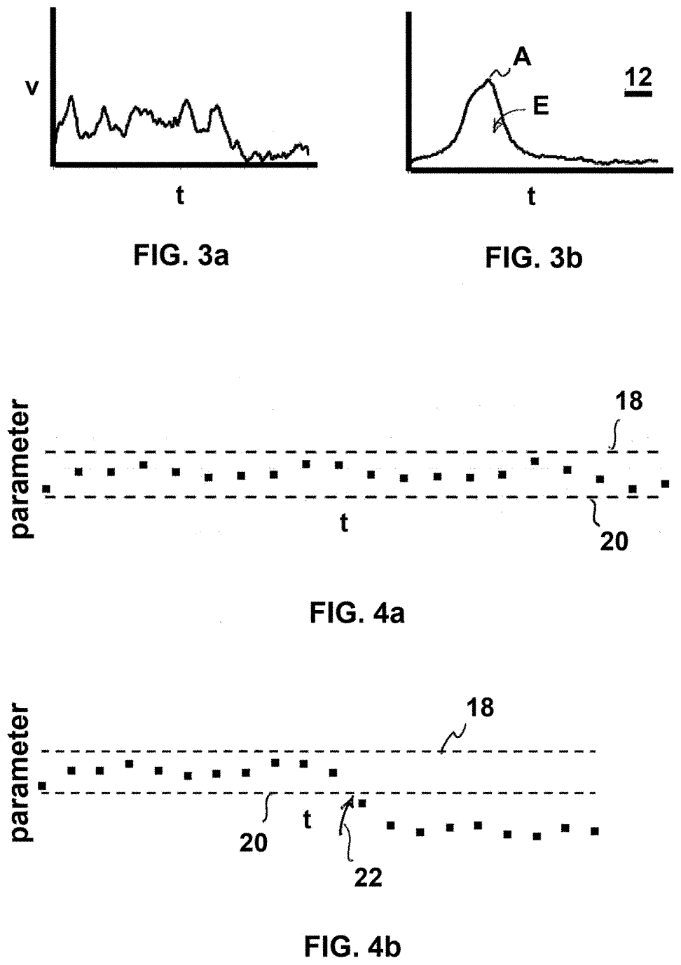

In order to ensure particularly high reliability of the monitoring system 1, the recorded signal signatures 12 are subjected to a plausibility check in the evaluation unit 14 before they are further processed. The knowledge is used here that the detected signal signatures 12 have a characteristic profile due to the measurement and system. This can be used to differentiate between a measurement event that is actually relevant for the measurement and monitoring or only a noise event that is not to be taken into account in the evaluation. For comparison, FIG. 3a shows the intensity spectrum (as a function of time) of a noise event and in FIG. 3b that of a signal triggered by a droplet 2. To validate or check such a signal spectrum 12 for plausibility, it is possible, for example, to check whether the ratio of maximum amplitude A and total energy E is in a predetermined interval, or other criteria characteristic of the signal shape can also be used. In particular, a comparison can be made with a target profile stored in the evaluation unit 14.

During the actual spray monitoring, the evaluation unit 14 then uses the measured signal signatures 12 recognized as valid and checked for plausibility to determine a diagnostic parameter for the spray process, which can then be used in an assigned control or regulation system. In this case, one or more evaluation parameters, which can be taken from the signal signatures 12 and are selected as suitable for the respective application, are first defined, which is then monitored with regard to its temporal course, i.e. in particular with regard to its deviations from the previous events. For each detected droplet 2, the selected parameters are calculated from the scattered light signal.

In particular, using current measurement technology, thousands of such events per second can usually be measured in real time in a spray. In a preferred embodiment, the parameters of the events calculated in this way are summarized (e.g. averaged) and evaluated in a short time window (for example in the millisecond range) for display and improved analysis. A representation over time of an exemplary measurement is shown in FIGS. 4a and 4b.

FIG. 4a shows the case that the parameter determined in this way, viewed over time, remains within a tolerance band defined by a lower limit 18 and an upper limit 20. In contrast, FIG. 4b shows a case in which the monitored parameter leaves the tolerance band at a moment indicated by the arrow 22 by falling below the lower limit 18. In the evaluation unit 14 it is concluded from these results in the first case (FIG. 4a) that the monitored process is running in a stable manner and, for example, a “system ok” signal is generated as a diagnostic parameter. In the second case (FIG. 4b), however, it is concluded that there has been a change in the spraying process and thus that action is required. In this case, a “warning” signal or, in the case of quantitative correlation with the monitored spraying process, a quantitative feedback signal for the system control, with which the system is returned to the desired spray behavior, could be generated as a diagnostic parameter.

This procedure is only shown as an example; the reference values or the lower limit 18 and the upper limit 20 do not have to be constant over time. The parameters do not have to be compared with a reference value—just changing the parameters can provide information about a change in the spray and the need for action.

The parameters determined during the evaluation of the signal signatures 12 are selected particularly suitably with regard to the system process to be monitored. In particular, the following parameters can be preferred for the evaluation under the following conditions:
The maximum amplitude A: as has been shown, this correlates proportionally to the droplet size. In the case of an atomization or spray process, for example, if the atomizing air is increased, a smaller droplet size is expected, so this value should also decrease. This value is therefore suitable, for example, for monitoring or regulating the air supply to the atomizer.
The total energy E: This value correlates inversely with the drop speed. For example, if steering airs are decreased in an atomizer, slower drops are expected. This should increase this value.
The frequency of occurrence of the signal signatures 12: This value correlates proportionally to the number of drops or to the spray throughput.
The time offset between signals in different channels, i.e. at different detectors 10a, 10b: this parameter, usually referred to as “time shift”, correlates proportionally to the droplet size and inversely with the droplet speed.

All of the parameters mentioned are sensitive to the problems that may arise in a painting system, but also in general in a spraying or atomizing process, such as nozzle wear, material changes (inhomogeneity), instability of the operating parameters and the like, and are therefore suitable per se for process monitoring.

### REFERENCE NUMERALS

1 monitoring system
2 droplets
4 jet of droplets
6 light source
8 beam of light
10a, 10b radiation detector
12 signal signature
14 evaluation unit
16 area
18 lower limit
20 upper limit
22 arrow
A amplitude
E total energy

1. A method for monitoring media flow of a droplet jet, in which signal signatures assigned to individual droplets are continuously recorded by time-resolved measurement of intensity of scattered light of a light beam crossing the droplet jet, from which a diagnostic parameter characteristic of the droplet jet is determined.

2. The method of claim 1, in which the diagnostic parameter is determined based at least in part on deviations from signal signatures detected at different times.

3. The method of claim 1, in which the signal signatures are validated based at least in part on comparison with a stored target profile, whereby only signal signatures recognized as valid are taken into account for determining the diagnostic parameters.

4. The method of claim 1, in which, to determine the diagnostic parameter, the respective signal signature is assessed per unit of time based on one or more evaluation parameters comprising maximum amplitude, total energy corresponding to the time integral over the amplitude curve, or frequency of occurrence of the signal signatures.

5. The method of claim 1, in which the signal signatures are detected in a plurality of detectors.

6. The method of claim 5, wherein a time offset of the signal signatures between different detectors is evaluated to determine the diagnostic parameter.

7. A method for producing a coating by feeding a jet of droplets to a surface to be coated, in which the media flow of the jet of droplets is monitored using the method of claim 1.

8. A method for operating a coating system, wherein throughput of sprayed droplets is monitored with the method of claim 1 and the diagnostic parameter determined is used as an input variable for controlling the coating system.

9. A method for operating a spray drying system, wherein throughput of food particles is monitored with the method of claim 1 and the diagnostic parameter determined is used as an input variable for controlling the spray drying system.

10. A method for operating a spray adhesive system, wherein throughput of adhesive particles is monitored with the method of claim 1 and the diagnostic parameter determined is used as an input variable for controlling the spray adhesive system.
